(19) United States
(12) Patent Application Publication
(10) Pub. No.: US 2025/0225200 A1
(43) Pub. Date: Jul. 10, 2025

(54) SPLINE CURVE INTERPOLATION METHOD AND SYSTEM BASED ON ARC LENGTH PREDICTION AND ITERATIVE TUNING

(71) Applicant: Shandong University, Jinan (CN)

(72) Inventors: Shuai JI, Jinan (CN); Zuguang HUANG, Beijing (CN); Ruijuan XUE, Beijing (CN); Hepeng NI, Jinan (CN)

(73) Assignee: Shandong University, Jinan (CN)

(21) Appl. No.: 19/009,718

(22) Filed: Jan. 3, 2025

(30) Foreign Application Priority Data
Jan. 9, 2024 (CN) 202410028083.9

(51) Int. Cl. G06F 17/17

(52) U.S. Cl. CPC G06F 17/17

(57) ABSTRACT

Disclosed is a spline curve interpolation method and system based on arc length prediction and iterative tuning in the technical field of numerical control, the method including: obtaining a spline curve and calculating a theoretical interpolation distance of the spline curve; predicting through interpolation a feed arc length based on a historical relationship between an arc length and a chord length of the spline curve; calculating parameters of the spline curve through Taylor expansion; obtaining a feed chord length in a current cycle based on the parameters and parametric equations of the spline curve; and determining a velocity fluctuation based on a theoretical to-be-interpolated arc length and an actual feed chord length of the spline curve, iteratively calculating a value of a parameter corresponding to a target point of the spline curve by taking the velocity fluctuation as a target.

### CROSS-REFERENCE TO RELATED APPLICATIONS

The application claims priority to Chinese patent application No. 202410028083.9, filed on Jan. 9, 2024, the entire contents of which are incorporated herein by reference.

### TECHNICAL FIELD

The present invention relates to the field of numerical control technology, and in particular, to a spline curve interpolation method and system based on arc length prediction and iterative tuning.

### BACKGROUND

A spline curve refers to a smooth curve obtained from a given set of control points, the shape of which is controlled by these points. Spline curves are widely used in the design and manufacturing of complex profiles. Spline curve interpolation is a core technology for realizing complex curved motions in high-end equipment such as robots and machine tools.

Currently, the Taylor expansion method is the most commonly used spline curve interpolation method. For spline curve interpolation using the Taylor expansion method, the theoretical feed distance calculated according to the feed velocity and interpolation cycle is the arc length of the curve. However, in the actual operation of a numerical control system, linear feeding is adopted in an interpolation cycle, and the actual feed distance is the chord length corresponding to the arc length. Therefore, this will cause inconsistency between the theoretical feed distance and the actual feed distance of an interpolation operation, and also a deviation between the theoretical velocity and the actual velocity, further resulting in velocity fluctuations and operational instability of robots, machine tools, and other equipment.

### SUMMARY

In view of the foregoing problems, the present invention aims to provide a spline curve interpolation method and system based on arc length prediction and iterative tuning, which can effectively reduce velocity fluctuations without significant changes in the computational burden.

The objective of the present invention is achieved by the following technical solution: a spline curve interpolation method based on arc length prediction and iterative tuning, including the following steps:
obtaining a spline curve and calculating a theoretical interpolation distance of the spline curve;
predicting through interpolation a feed arc length based on a historical relationship between an arc length and a chord length of the spline curve;
calculating parameters of the spline curve through Taylor expansion;
obtaining a feed chord length in a current cycle based on the parameters and parametric equations of the spline curve; and
determining a velocity fluctuation based on a theoretical to-be-interpolated arc length and an actual feed chord length of the spline curve, iteratively calculating a value of a parameter corresponding to a target point of the spline curve by taking the velocity fluctuation as a target, and updating a corresponding interpolation table.

Furthermore, the step of obtaining a spline curve and calculating a theoretical interpolation distance of the spline curve includes:
obtaining any continuous spline curve;
obtaining a current feed velocity vₖ and a current interpolation cycle T of the spline curve; and
calculating a feed distance vₖT in the current interpolation cycle based on the current feed velocity vₖ and the current interpolation cycle T.

Furthermore, the step of predicting through interpolation a feed arc length based on a historical relationship between an arc length and a chord length of the spline curve includes:
setting a current to-be-predicted interpolation point as a k-th interpolation point, a chord length and arc length of a (k−1)-th interpolation point as sₖ₋₁ and lₖ₋₁ respectively, a chord length and arc length of a (k−2)-th interpolation point as sₖ₋₂ and lₖ₋₂ respectively, and a corresponding arc length as sₖ₁ when a feed chord length is vₖT predicted by polynomial interpolation.

Furthermore, the step of calculating parameters of the spline curve through Taylor expansion includes:
calculating an initial value uₖ⁰ of a parameter of the spline curve corresponding to the k-th interpolation point through Taylor expansion;
the Taylor expansion is as follows:

$${u}_{k}^{0} \approx {u}_{k - 1} + \frac{Sk 1}{\sqrt{{( \frac{dx}{du} )}^{2} + {( \frac{dy}{du} )}^{2} + {( \frac{dz}{du} )}^{2}} {\vert}_{u = {u}_{k - 1}}}$$

where uₖ₋₁ represents a parameter of the spline curve corresponding to the (k−1)-th interpolation point.

Furthermore, the step of obtaining a feed chord length in a current cycle based on the parameters and parametric equations of the spline curve includes:
calculating spatial coordinates xₖ, yₖ, zₖ of the k-th interpolation point based on the initial value uₖ⁰ of the parameter of the spline curve corresponding to the k-th interpolation point and the curve parameter equations x(u), y(u), z(u); and
calculating the feed chord length lₖ⁰ corresponding to the k-th interpolation point in the current cycle based on the formula

$${l}_{k}^{0} = \sqrt{{( {x}_{k} - {x}_{k - 1} )}^{2} + {( {y}_{k} - {y}_{k - 1} )}^{2} + {( {z}_{k} - {z}_{k - 1} )}^{2}} .$$

Furthermore, the step of determining a velocity fluctuation based on a theoretical to-be-interpolated arc length and an actual feed chord length of the spline curve, iteratively calculating a value of a parameter corresponding to a target point of the spline curve by taking the velocity fluctuation as a target, and updating a corresponding interpolation table includes:
recording a difference between the feed distance vₖT in the current interpolation cycle and the feed chord length corresponding to the interpolation point in the current cycle as the velocity fluctuation, and setting an iteration goal based on the velocity fluctuation; and
iteratively calculating the value of the parameter uₖⁱ corresponding to the k-th interpolation point of the spline curve by the following formula based on the iteration goal:

$$\{ \begin{matrix}Δ {l}_{k} = {y}_{k} T - {l}_{k}^{i} \\ {l}_{k}^{i} = \sqrt{{( {x}_{k}^{i} - {x}_{k}^{i - 1} )}^{2} + {( {y}_{k}^{i} - {y}_{k}^{i - 1} )}^{2} + {( {z}_{k}^{i} - {z}_{k}^{i - 1} )}^{2}} \\ {u}_{k}^{i} - {u}_{k}^{i - 1} + \frac{Δ {l}_{k}}{\sqrt{{( \frac{dx}{du} )}^{2} + {( \frac{dy}{du} )}^{2} + {( \frac{dz}{du} )}^{2}} {\vert}_{u = {u}_{k}^{i - 1}}}\end{matrix}$$

where Δlₖ represents the velocity fluctuation; i represents the number of iterations; lₖⁱ represents an arc length of the k-th interpolation point after an i-th iteration; and uₖⁱ represents the value of the parameter of the k-th interpolation point after the i-th iteration.

Furthermore, the iteration goal includes:
determining whether Δlₖ is less than or equal to an upper limit value δ of the velocity fluctuation;
if so, exiting the iterative calculation, obtaining current spatial coordinates of the k-th interpolation point, and updating the interpolation table based on corresponding chord length and arc length; or
if not, continuing the iterative calculation.

Accordingly, the present invention further provides a spline curve interpolation system based on arc length prediction and iterative tuning, including:
a theoretical interpolation distance calculation module, configured to obtain a spline curve and calculate a theoretical interpolation distance of the spline curve;
an initial arc length value prediction module, configured to predict through interpolation a feed arc length based on a historical relationship between an arc length and a chord length of the spline curve;
a curve parameter solving module, configured to calculate parameters of the spline curve through Taylor expansion;
a velocity fluctuation calculation module, configured to obtain a feed chord length in a current cycle based on the parameters and parametric equations of the spline curve; and
an iterative calculation module, configured to determine a velocity fluctuation based on a theoretical to-be-interpolated arc length and an actual feed chord length of the spline curve, iteratively calculate a value of a parameter corresponding to a target point of the spline curve by taking the velocity fluctuation as a target, and update a corresponding interpolation table.

Compared with the prior art, the present invention has the following beneficial effects: the present invention provides a spline curve interpolation method and system based on arc length prediction and iterative tuning, which, based on continuity characteristics of high-order spline curves and a relationship between arc length and chord length in historical interpolation data, predicts an initial value of a to-be-interpolated arc length in a next interpolation cycle through polynomial fitting and obtains a target interpolation point using a velocity fluctuation rate as a target through Taylor expansion and iteration, thereby reducing both the velocity fluctuation rate and the computational burden for interpolation. The present invention implements a spline curve interpolation method based on arc length prediction and iterative tuning, which can effectively reduce velocity fluctuations and the deviation between the theoretical velocity and the actual velocity without significant changes in the computational burden, thereby improving the operational stability of robots, machine tools, and other equipment.

It can be seen that compared with the prior art, the present invention has outstanding substantive features and significant progress, and the beneficial effects of its implementation are also obvious.

### BRIEF DESCRIPTION OF THE DRAWINGS

To explain the technical solutions in the embodiments of the present invention or in the prior art more clearly, the following briefly describes the accompanying drawings required for describing the embodiments or the prior art. Apparently, the accompanying drawings in the following description show only some embodiments of the present invention, and a person of ordinary skill in the art may derive other drawings from these accompanying drawings without creative efforts.

FIG. 1 is a flowchart of a method according to an embodiment of the present invention;

FIG. 2 is a schematic diagram of an iteration process according to an embodiment of the present invention; and

FIG. 3 is a schematic structural diagram of a system according to an embodiment of the present invention.

### REFERENCE SIGNS

1. theoretical interpolation distance calculation module; 2. initial arc length value prediction module; 3. curve parameter solving module; 4. velocity fluctuation calculation module; and 5. iterative calculation module.

### DETAILED DESCRIPTION OF THE EMBODIMENTS

In order to enable those skilled in the art to better understand the technical solutions of the present invention, the present invention is further illustrated in detail below in conjunction with the accompanying drawings and specific embodiments. Apparently, the embodiments described are only a part rather than all of the embodiments of the present invention. Based on the embodiments in the present invention, all other embodiments obtained by those of ordinary skill in the art without creative efforts shall fall within the protection scope of the present invention.

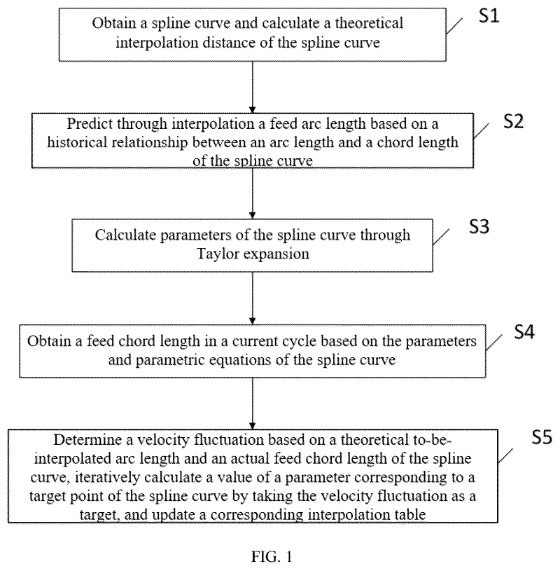

As shown in FIG. 1, an embodiment of the present invention provides a spline curve interpolation method based on arc length prediction and iterative tuning, including the following steps:
S1: obtaining a spline curve and calculating a theoretical interpolation distance of the spline curve.

In specific implementations, this step implements the calculation of the theoretical interpolation distance. Specifically, any continuous spline curve is obtained firstly; and then a current feed velocity vₖ and a current interpolation cycle T of the spline curve are obtained based on the obtained spline curve. Finally, a feed distance vₖT in the current interpolation cycle is calculated based on the current feed velocity vₖ and the current interpolation cycle T.
S2: predicting through interpolation a feed arc length based on a historical relationship between an arc length and a chord length of the spline curve.

In specific implementations, if a current to-be-predicted interpolation point is set as a k-th interpolation point, the chord length and arc length of a (k−1)-th interpolation point and a (k−2)-th interpolation point are (sₖ₋₁, lₖ₋₁) and (sₖ₋₂, lₖ₋₂) respectively, and a corresponding arc length is sk1 when a feed chord length is vₖT predicted by polynomial interpolation. Here, more historical interpolation points and higher-order polynomial interpolation can be used as needed.
S3: calculating parameters of the spline curve through Taylor expansion.

In specific implementations, the first-order Taylor expansion shown in Formula (1) is used to solve for an initial value of a parameter uₖ⁰ of the spline curve, where uₖ₋₁ represents a parameter of the spline curve corresponding to a previous interpolation point.

$${u}_{k}^{0} \approx {u}_{k - 1} + \frac{Sk 1}{\sqrt{{( \frac{dx}{du} )}^{2} + {( \frac{dy}{du} )}^{2} + {( \frac{dz}{du} )}^{2}} {\vert}_{u = {u}_{k - 1}}} \qquad ( 1 )$$

where uₖ⁰ represents an initial value of a parameter of the spline curve corresponding to the k-th interpolation point; and uₖ₋₁ represents a parameter of the spline curve corresponding to the (k−1)-th interpolation point
S4: obtaining a feed chord length in a current cycle based on the parameters and parametric equations of the spline curve.

In specific implementations, corresponding space coordinates xₖ, yₖ, zₖ are calculated based on the initial value of the parameter uₖ⁰ and the parametric equations x(u), y(u), z(u) of the spline curve, and the feed chord length lₖ⁰ in the current cycle is obtained by Formula (2):

$${l}_{k}^{0} = \sqrt{{( {x}_{k} - {x}_{k - 1} )}^{2} + {( {y}_{k} - {y}_{k - 1} )}^{2} + {( {z}_{k} - {z}_{k - 1} )}^{2}} \qquad ( 2 )$$

S5: determining a velocity fluctuation based on a theoretical to-be-interpolated arc length and an actual feed chord length of the spline curve, iteratively calculating a value of a parameter corresponding to a target point of the spline curve by taking the velocity fluctuation as a target, and updating a corresponding interpolation table.

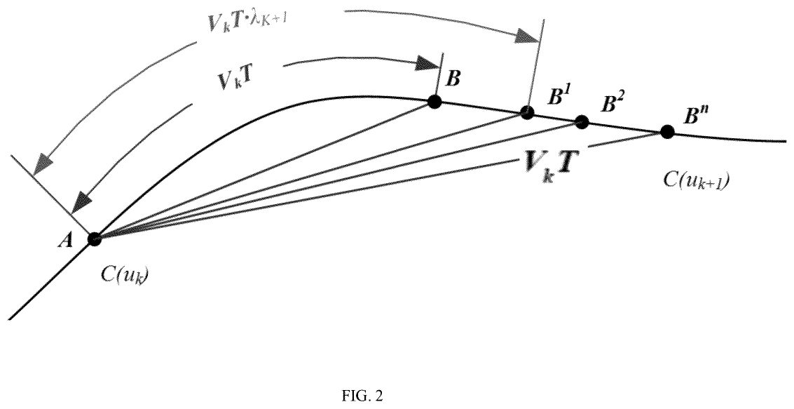

In specific implementations, Δlk is recorded as a difference between the theoretical to-be-interpolated arc length and the actual feed chord length of the spline curve, i.e. the velocity fluctuation, which is taken as the target to iteratively calculate the value of the parameter uk corresponding to the target point of the spline curve until the Δlk is less than an upper limit value δ of the velocity fluctuation. The iteration formula is shown by Formula (3), and the iteration process is shown in FIG. 2.

$$\{ \begin{matrix}Δ {l}_{k} = {y}_{k} T - {l}_{k}^{i} \\ {l}_{k}^{i} = \sqrt{{( {x}_{k}^{i} - {x}_{k}^{i - 1} )}^{2} + {( {y}_{k}^{i} - {y}_{k}^{i - 1} )}^{2} + {( {z}_{k}^{i} - {z}_{k}^{i - 1} )}^{2}} \\ {u}_{k}^{i} - {u}_{k}^{i - 1} + \frac{Δ {l}_{k}}{\sqrt{{( \frac{dx}{du} )}^{2} + {( \frac{dy}{du} )}^{2} + {( \frac{dz}{du} )}^{2}} {\vert}_{u = {u}_{k}^{i - 1}}}\end{matrix} \qquad ( 3 )$$

where Δlₖ represents the velocity fluctuation; i represents the number of iterations; lₖⁱ represents an arc length of the k-th interpolation point after an i-th iteration; and uₖⁱ represents the value of the parameter of the k-th interpolation point after the i-th iteration.

After each iteration is completed, it is determined whether Δlk is less than or equal to the upper limit value δ of the velocity fluctuation:
if so, exit the iterative calculation, obtain current spatial coordinates of the k-th interpolation point, and update the interpolation table based on corresponding chord length and arc length; or if not, continue the iterative calculation.

The above steps are repeated until the interpolation of the entire continuous spline curve is completed. In this way, velocity fluctuations during spline curve interpolation can be effectively reduced.

Through the above steps, the interpolation of the spline curve is completed, thereby obtaining the Bⁿ interpolation point shown in FIG. 2 so that the chord length ABⁿ approaches the feed distance vₖT in the current interpolation cycle, where vₖ represents the current feed velocity; and T represents the interpolation cycle.

The present invention provides a spline curve interpolation method based on arc length prediction and iterative tuning, which, based on continuity characteristics of high-order spline curves and a relationship between arc length and chord length in historical interpolation data, predicts an initial value of a to-be-interpolated arc length in a next interpolation cycle through polynomial fitting and obtains a target interpolation point using a velocity fluctuation rate as a target through Taylor expansion and iteration, thereby reducing both the velocity fluctuation rate and the computational burden for interpolation.

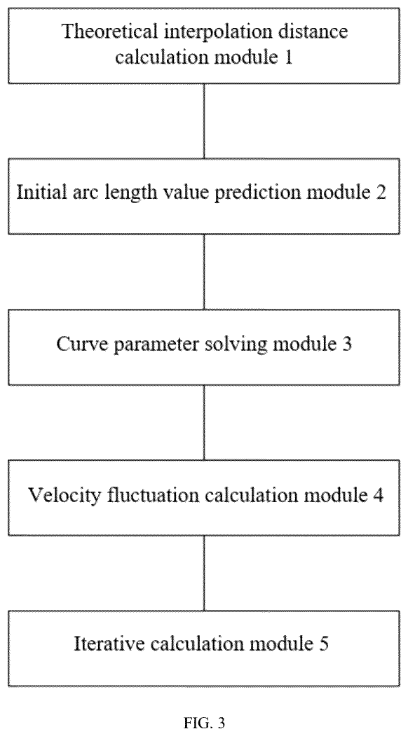

As shown in FIG. 3, the present invention further provides a spline curve interpolation system based on arc length prediction and iterative tuning, including a theoretical interpolation distance calculation module 1, an initial arc length value prediction module 2, a curve parameter solving module 3, a velocity fluctuation calculation module 4, and an iterative calculation module 5.

The theoretical interpolation distance calculation module 1 is configured to obtain a spline curve and calculate a theoretical interpolation distance of the spline curve.

The initial arc length value prediction module 2 is configured to predict through interpolation a feed arc length based on a historical relationship between an arc length and a chord length of the spline curve.

The curve parameter solving module 3 is configured to calculate parameters of the spline curve through Taylor expansion.

The velocity fluctuation calculation module 4 is configured to obtain a feed chord length in a current cycle based on the parameters and parametric equations of the spline curve.

The iterative calculation module 5 is configured to determine a velocity fluctuation based on a theoretical to-be-interpolated arc length and an actual feed chord length of the spline curve, iteratively calculate a value of a parameter corresponding to a target point of the spline curve by taking the velocity fluctuation as a target, and update a corresponding interpolation table.

The specific implementation of the spline curve interpolation system based on arc length prediction and iterative tuning in the embodiment is basically consistent with that of the above-described spline curve interpolation method based on arc length prediction and iterative tuning, and will not be elaborated herein.

To sum up, the present invention can effectively reduce velocity fluctuations without significant changes in the computational burden.

Various embodiments in the specification are described in a progressive manner, and each embodiment focuses on the differences from the other embodiments, and the same or similar parts between the various embodiments can refer to each other. Since the system embodiments correspond to the method embodiments, they are described in a more concise manner. For relevant content, reference may be made to the description of the method embodiments.

In the several embodiments provided by the present invention, it should be understood that the disclosed system and method may be implemented in other manners. The system embodiments described above are only for illustration. For example, the division of the units is only a logical function division. In actual implementations, there may be other division means. For example, multiple units or components may be combined or may be integrated into another system, or some features may be disregarded or left unimplemented. In addition, the displayed or discussed mutual coupling, direct coupling, or communication connection may be achieved through some interfaces; and indirect coupling or communication connection of systems or units may be in electrical, mechanical, or other forms.

The units described as separate components may or may not be physically separated. The components displayed as units may or may not be physical units, that is, they may be located in one place, or may be distributed on multiple network units. Some or all of the units may be selected according to actual needs to achieve the objectives of the solutions of the embodiments.

In addition, functional modules in various embodiments of the present invention can be integrated into one processing unit, or each module physically exists separately, or two or more modules are integrated into one unit.

Similarly, processing units in various embodiments of the present invention can be integrated into one functional module, or each processing unit physically exists separately, or two or more processing units are integrated into one functional module.

The steps of the method or algorithm described in conjunction with the embodiments disclosed herein may be implemented directly in hardware, in software modules executed by a processor, or in a combination of the two. The software modules may be placed in random access memories (RAMs), memories, read-only memories (ROMs), electrically programmable ROMs, electrically erasable programmable ROMs, registers, hard disks, removable disks, CD-ROMs, or any other form of storage medium known in the art.

Finally, it should be noted that relational terms herein, such as first and second, are only used to distinguish one entity or operation from another entity or operation, and do not necessarily require or imply any such actual relationship or order among these entities or operations. Moreover, the terms “include”, “comprise”, or any other variants thereof are intended to cover non-exclusive inclusion, so that a process, method, item, or device including a series of elements includes not only those elements but also other elements not explicitly listed, or further includes inherent elements of such process, method, item, or device. An element preceded by “includes a . . . ” does not, without more constraints, preclude the existence of additional identical elements in the process, method, article, or device that includes the element.

The spline curve interpolation method and system based on arc length prediction and iterative tuning provided by the present invention have been described in detail above. The principle and implementation of the present invention are elaborated through specific embodiments. The description of the above embodiments is only used to help understand the method and core idea of the present invention. It should be noted that, for those of ordinary skill in the art, various improvements and modifications may be made without departing from the principle of the present invention, and such improvements and modifications shall also fall within the protection scope of the present invention.

What is claimed is:

1. A method for spline curve interpolation based on arc length prediction and iterative tuning, comprising the following steps:
obtaining a spline curve and calculating a theoretical interpolation distance of the spline curve;
predicting through interpolation a feed arc length based on a historical relationship between an arc length and a chord length of the spline curve;
calculating parameters of the spline curve through Taylor expansion;
obtaining a feed chord length in a current cycle based on the parameters and parametric equations of the spline curve; and
determining a velocity fluctuation based on a theoretical to-be-interpolated arc length and an actual feed chord length of the spline curve, iteratively calculating a value of a parameter corresponding to a target point of the spline curve by taking the velocity fluctuation as a target, and updating a corresponding interpolation table, wherein
the step of obtaining the spline curve and calculating the theoretical interpolation distance of the spline curve comprises:
obtaining any continuous spline curve;
obtaining a current feed velocity vₖ and a current interpolation cycle T of the spline curve; and
calculating a feed distance vₖT in the current interpolation cycle T based on the current feed velocity vₖ and the current interpolation cycle T;
the step of predicting through interpolation the feed arc length based on the historical relationship between the arc length and lithe chord length of the spline curve comprises:
setting a current to-be-predicted interpolation point as a k-th interpolation point, a chord length and arc length of a (k−1)-th interpolation point as sₖ₋₁ and lₖ₋₁ respectively, a chord length and arc length of a (k−2)-th interpolation point as sₖ₋₂ and lₖ₋₂ respectively, and a corresponding arc length as sₖ₁ when the predicated feed chord length corresponds to the feed distance vₖT predicted by polynomial interpolation;
the step of calculating the parameters of the spline curve through Taylor expansion comprises:
calculating an initial value uₖ⁰ of a parameter of the spline curve corresponding to the k-th interpolation point through Taylor expansion;
the Taylor expansion is as follows:
$${u}_{k}^{0} \approx {u}_{k - 1} + \frac{Sk 1}{\sqrt{{( \frac{dx}{du} )}^{2} + {( \frac{dy}{du} )}^{2} + {( \frac{dz}{du} )}^{2}} {\vert}_{u = {u}_{k - 1}}}$$
wherein uₖ₋₁ represents a parameter of the spline curve corresponding to the (k−1)-th interpolation point;
the step of obtaining the feed chord length in the current cycle based on the parameters and the parametric equations of the spline curve comprises:
calculating spatial coordinates xₖ, yₖ, zₖ of the k-th interpolation point based on the initial value uₖ⁰ of the parameter of the spline curve corresponding to the k-th interpolation point and the curve parameter equations defining spatial coordinates as functions of a curve parameter u, namely x=x(u), y=y(u), and z=z(u); and
calculating a feed chord length lₖ⁰ corresponding to the k-th interpolation point in the current cycle based on the formula
$${l}_{k}^{0} = \sqrt{{( {x}_{k} - {x}_{k - 1} )}^{2} + {( {y}_{k} - {y}_{k - 1} )}^{2} + {( {z}_{k} - {z}_{k - 1} )}^{2}} ;$$
and
the step of determining the velocity fluctuation based on the theoretical to-be-interpolated arc length and the actual feed chord length of the spline curve, iteratively calculating the value of the parameter corresponding to the target point of the spline curve by taking the velocity fluctuation as the target, and updating the corresponding interpolation table comprises:
recording a difference between the feed distance vₖT in the current interpolation cycle and the feed chord length corresponding to the current to be predicated interpolation point in the current cycle as the velocity fluctuation, and setting an iteration goal based on the velocity fluctuation; and
iteratively calculating a value of the parameter uₖⁱ corresponding to the k-th interpolation point of the spline curve by the following formula based on the iteration goal:
$$\{ \begin{matrix}Δ {l}_{k} = {y}_{k} T - {l}_{k}^{i} \\ {l}_{k}^{i} = \sqrt{{( {x}_{k}^{i} - {x}_{k}^{i - 1} )}^{2} + {( {y}_{k}^{i} - {y}_{k}^{i - 1} )}^{2} + {( {z}_{k}^{i} - {z}_{k}^{i - 1} )}^{2}} \\ {u}_{k}^{i} - {u}_{k}^{i - 1} + \frac{Δ {l}_{k}}{\sqrt{{( \frac{dx}{du} )}^{2} + {( \frac{dy}{du} )}^{2} + {( \frac{dz}{du} )}^{2}} {\vert}_{u = {u}_{k}^{i - 1}}}\end{matrix}$$
wherein Δlₖ represents the velocity fluctuation; i represents a number of iterations; lₖⁱ represents an arc length of the k-th interpolation point after an i-th iteration; and uₖⁱ represents the value of the parameter of the k-th interpolation point after the i-th iteration.

2. The method of claim 1, wherein the iteration goal comprises:
determining whether Δlₖ is less than or equal to an upper limit value δ of the velocity fluctuation;
if so, exiting a iterative calculation, obtaining current spatial coordinates of the k-th interpolation point, and updating the corresponding interpolation table based on corresponding chord length and arc length; or
if not, continuing the iterative calculation.

3. A spline curve interpolation system based on arc length prediction and iterative tuning, comprising:
a theoretical interpolation distance calculation processor, configured to obtain a spline curve and calculate a theoretical interpolation distance of the spline curve;
an initial arc length value prediction processor, configured to predict through interpolation a feed arc length based on a historical relationship between an arc length and a chord length of the spline curve;
a curve parameter solving processor, configured to calculate parameters of the spline curve through Taylor expansion;
a velocity fluctuation calculation processor, configured to obtain a feed chord length in a current cycle based on the parameters and parametric equations of the spline curve; and
an iterative calculation processor, configured to determine a velocity fluctuation based on a theoretical to-be-interpolated arc length and an actual feed chord length of the spline curve, iteratively calculate a value of a parameter corresponding to a target point of the spline curve by taking the velocity fluctuation as a target, and update a corresponding interpolation table, wherein
the theoretical interpolation distance calculation processor is specifically used for:
obtaining any continuous spline curve;
obtaining a current feed velocity vₖ and a current interpolation cycle T of the spline curve; and
calculating a feed distance vₖT in the current interpolation cycle T based on the current feed velocity vₖ and the current interpolation cycle T;
the initial arc length value prediction processor is specifically used for:
setting a current to-be-predicted interpolation point as a k-th interpolation point, a chord length and arc length of a (k−1)-th interpolation point as sₖ₋₁ and lₖ₋₁ respectively, a chord length and arc length of a (k−2)-th interpolation point as sₖ₋₂ and lₖ₋₂ respectively, and a corresponding arc length as sₖ₁ when the predicated feed chord length corresponds to the feed distance vₖT predicted by polynomial interpolation;
the curve parameter solving processor is specifically used for:
calculating an initial value uₖ⁰ of a parameter of the spline curve corresponding to the k-th interpolation point through Taylor expansion;
the Taylor expansion is as follows:
$${u}_{k}^{0} \approx {u}_{k - 1} + \frac{Sk 1}{\sqrt{{( \frac{dx}{du} )}^{2} + {( \frac{dy}{du} )}^{2} + {( \frac{dz}{du} )}^{2}} {\vert}_{u = {u}_{k - 1}}}$$
wherein uₖ₋₁ represents a parameter of the spline curve corresponding to the (k−1)-th interpolation point;
the velocity fluctuation calculation processor is specifically used for:
calculating spatial coordinates xₖ, yₖ, zₖ of the k-th interpolation point based on the initial value uₖ⁰ of the parameter of the spline curve corresponding to the k-th interpolation point and the curve parameter equations defining spatial coordinates as functions of a curve parameter u, namely x=x(u), y=v(u), and z=z(u); and
calculating the feed chord length lₖ⁰ corresponding to the k-th interpolation point in the current cycle based on the formula
$${l}_{k}^{0} = \sqrt{{( {x}_{k} - {x}_{k - 1} )}^{2} + {( {y}_{k} - {y}_{k - 1} )}^{2} + {( {z}_{k} - {z}_{k - 1} )}^{2}} ;$$
and
the iterative calculation processor is specifically used for:
recording a difference between the feed distance vₖT in the current interpolation cycle and the feed chord length corresponding to the interpolation point in the current cycle as the velocity fluctuation, and setting an iteration goal based on the velocity fluctuation; and
iteratively calculating a value of the parameter uₖⁱ corresponding to the k-th interpolation point of the spline curve by the following formula based on the iteration goal:
$$\{ \begin{matrix}Δ {l}_{k} = {y}_{k} T - {l}_{k}^{i} \\ {l}_{k}^{i} = \sqrt{{( {x}_{k}^{i} - {x}_{k}^{i - 1} )}^{2} + {( {y}_{k}^{i} - {y}_{k}^{i - 1} )}^{2} + {( {z}_{k}^{i} - {z}_{k}^{i - 1} )}^{2}} \\ {u}_{k}^{i} - {u}_{k}^{i - 1} + \frac{Δ {l}_{k}}{\sqrt{{( \frac{dx}{du} )}^{2} + {( \frac{dy}{du} )}^{2} + {( \frac{dz}{du} )}^{2}} {\vert}_{u = {u}_{k}^{i - 1}}}\end{matrix}$$
wherein Δlₖ represents the velocity fluctuation; i represents a number of iterations; lₖⁱ represents an arc length of the k-th interpolation point after an i-th iteration; and uₖⁱ represents the value of the parameter of the k-th interpolation point after the i-th iteration.
